(19) United States
(12) Patent Application Publication
(10) Pub. No.: US 2023/0273808 A1
(43) Pub. Date: Aug. 31, 2023

(54) CONFIDENTIAL OFFLOADING OF PERSISTENT STORAGE OPERATIONS IN CONFIDENTIAL COMPUTING ENVIRONMENTS

(71) Applicant: Mellanox Technologies, Ltd., Yokneam (IL)

(72) Inventors: Ahmad Atamli, Oxford (GB); Meni Orenbach, Giv'atayim (IL); Miriam Menes, Tel Aviv (IL); Shahaf Shuler, Lohamei HaGeta'ot (IL)

(21) Appl. No.: 18/104,086

(22) Filed: Jan. 31, 2023

Related U.S. Application Data
(60) Provisional application No. 63/314,826, filed on Feb. 28, 2022.

(51) Int. Cl. G06F 9/455

(52) U.S. Cl. CPC G06F 9/45558; G06F 2009/45583; G06F 2009/45587; G06F 2009/45595

(57) ABSTRACT

The technology disclosed herein enables a Trusted Execution Environment (TEE) to be extended to an auxiliary device that handles persistently storing data in a security enhanced manner. Extending the trusted computing base to the auxiliary device may involve establishing an auxiliary TEE in the auxiliary device and a trusted communication link between the primary and auxiliary TEEs. The primary TEE may include the computing resources of the primary devices (e.g., CPU and host memory) and the auxiliary TEE may include the computing resources of the auxiliary devices (e.g., hardware accelerators and auxiliary memory). The trusted communication link may enable the auxiliary TEE to access data of the primary TEE that is otherwise inaccessible to all software executing external to the primary TEE (e.g., host operating system and hypervisor). The auxiliary device may use the auxiliary TEE to process the data to avoid compromising the security enhancements provided by the primary TEE.

### REFERENCE TO RELATED APPLICATIONS

This application claims the benefit of U.S. Provisional Application No. 63/314,826, filed Feb. 28, 2022, which is incorporated by reference herein.

### TECHNICAL FIELD

The present disclosure generally relates to using confidential computing techniques to establish a trusted computing base within a host device, and more specifically relates to expanding the trusted computing base to include hardware accelerators that process and persistently store data of the confidential computing environment.

### BACKGROUND

Modern computer systems often use confidential computing to enhance data security. Data security traditionally involves encrypting data when the data is stored on disk and when the data is in transit and with confidential computing the data is also encrypted while the data is in-use (e.g., stored in memory or processor cache). Confidential computing may supplement the encryption with integrity verification, replay protection, or a combination thereof.

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 depicts a high-level block diagram of an example computing environment that uses an auxiliary device to store data of a trusted execution environment in a persistent storage device, in accordance with one or more aspects of the present disclosure;

FIG. 2 depicts a block diagram of an example auxiliary device that uses a trusted execution environment to process and persistently store data of another trusted execution environment, in accordance with one or more aspects of the present disclosure;

FIGS. 3A-3B schematically illustrate example implementations of a trusted computing base spanning over a host device and an auxiliary device;

FIG. 4 depicts a block diagram of an example trusted execution environment, in accordance with one or more aspects of the present disclosure;

FIG. 5 depicts a block diagram of example components and modules for establishing the trusted execution environment of FIG. 4, in accordance with one or more aspects of the present disclosure;

FIG. 6 depicts a flow chart of a method performed by an auxiliary device to persistently store data of a trusted execution environment, in accordance with one or more aspects of the present disclosure;

FIG. 7 depicts a block diagram of an example computing system operating in accordance with the examples of the present disclosure.

### DETAILED DESCRIPTION

Modern computing environments often use aspects of confidential computing to establish trust relationships with a portion of a host device. The trust relationship may be established between different programs or devices and may be based on one or more integrity checks. The portion of the host device that is trusted may be referred to as the trusted computing base (TCB) and may include both hardware and software of the host device. In one example, the trust relationship may be established using Trusted Execution Environments (TEEs). A trusted execution environment may be implemented at a hardware level using the primary devices of a host, such as the Central Processing Unit (CPU). The CPU can provide hardware-level encryption that protects the data of a process from being accessed by the operating system that manages the process. In computer systems that use hardware virtualization, an entire virtual machine (VM) can be executed in a trusted execution environment and the data of the virtual machine that is stored in main memory can remain inaccessible to the hypervisor and host operating system that manage the virtual machine. Most trusted execution environments are primary trusted execution environments that are established using the primary devices of a host device and may not extend to auxiliary devices that provide hardware acceleration. This may cause the primary devices to consume more computing resources and cause the auxiliary devices to be underutilized, bypassed, or deactivated in order to enhance data security.

Aspects of the present disclosure address the above and other deficiencies by providing technology that enables the trusted computing base to be extended to one or more auxiliary devices. Extending the trusted computing base to the auxiliary device may involve establishing an auxiliary TEE in the auxiliary device and a trusted communication link between the primary and auxiliary TEEs. The primary TEE may include the computing resources of the primary devices (e.g., CPU and host memory) and the auxiliary TEE may include the computing resources of the auxiliary devices (e.g., hardware accelerators and auxiliary memory). The trusted communication link may enable the auxiliary TEE to access data of the primary TEE that is otherwise inaccessible to all software executing external to the primary TEE (e.g., host operating system and hypervisor). The auxiliary device may use the auxiliary TEE to process the data to avoid compromising the security enhancements provided by the primary TEE.

The auxiliary device may process and persistently store the data by performing one or more data processing tasks. The data processing tasks may involve encrypting/decrypting, encoding/decoding, compressing/decompressing, sending/receiving, reading/writing, other processing task, or a combination thereof. The data processing performed by the auxiliary device may replace or supplement the data processing performed by the CPU of the host device. In one example, the auxiliary device may be represented by a Data Processing Unit (DPU) that uses hardware accelerators to process data that is in-use by the primary TEE and can store the processed data in a persistent storage device (e.g., Solid-state Storage Drive (SSD)). In this example, the primary TEE may be referred to as a CPU-TEE and the auxiliary TEE may be referred to as a DPU-TEE.

The technology described herein improves the field of computer security by enabling a host device in a Confidential Computing environment (e.g., Trusted Computing environment) to provide better performance and security. In particular, aspects of the disclosed technology may increase the performance of the host device by enabling a trusted execution environment to offload data processing tasks in a security enhanced manner from a primary device (e.g., CPU) to one or more auxiliary devices (e.g., DPUs, GPUs, NICs, or other controllers). In one example, the auxiliary device may emulate the features of a storage controller and enable data in a trusted execution environment to be moved more quickly to and from a locally accessible or remotely accessible persistent storage device. Moving the data more quickly may be especially useful for backup, recovery, synchronization, or migration of the trusted execution environment and host device. In addition, aspects of the disclosed technology may increase the security by minimizing any increase to the attack surface that occurs when extending the trusted computing base to include the auxiliary device. In one example, aspects of the disclosed technology may also or alternatively enable the operation of the auxiliary device to be customized by a user device. The customizations may involve updating settings, configurations, executable code, other data or a combination thereof. This may be particularly advantageous in a cloud computing environment where a cloud consumer may want data of a workload to be inaccessible to the Cloud Service Provider (CSP). The cloud consumer may now be able to provide a customized workload for both the primary devices (e.g., CPUs) and the auxiliary devices (e.g., DPUs, GPUs, or NIC) and enhance confidentiality, integrity, or a combination thereof.

In some implementations, a trusted virtual machine (VM) running in a TEE implemented by the processor of the host device may communicate, via a trusted communication link, with another TEE implemented by the auxiliary device, thus forming a trusted computing base (TCB). In an illustrative example, the auxiliary device may be represented by a data processing unit (DPU) implementing a peripheral device controller, such as a network interface controller (NIC). The peripheral device controller may include one or more processors, including general purpose and/or specialized processors. The peripheral device controller may further include a host interface controller (e.g., a Peripheral Component Interconnect Express (PCIe) switch) implementing an interface between the host device and the peripheral device controller. The auxiliary device may further include another processor (e.g., a general purpose or a specialized processor) implementing an interface between a storage device and the auxiliary device (e.g., a Non-Volatile Memory Express (NVMe)-compliant interface for communicating with a storage device). This processor may, in various implementations, be inside or outside of the TCB perimeter.

In an illustrative example, the processor implementing the storage device interface may be untrusted (and thus is excluded from the TCB perimeter). In operation, the trusted VM may transmit, via the trusted communication link, the data to be stored on the storage device to the peripheral device controller. The peripheral device controller may encrypt and optionally compress the data. The encrypted data may supplied, via a shared memory buffer, to the untrusted processor of the auxiliary device for transmitting to the storage device.

In another illustrative example, the processor implementing the storage device interface may be trusted (and thus is included into the TCB perimeter). Accordingly, upon receiving unencrypted data from the peripheral device controller, the trusted processor may encrypt and optionally compress the data before storing it on the storage device, as described in more detail below.

Various aspects of the above referenced methods and systems are described in details herein below by way of examples, rather than by way of limitation. The examples provided below discuss a computing environment that uses a combination of confidential computing and hardware level virtualization and executes virtual machines in trusted execution environments. In other examples, the confidential computing features can be substituted with different techniques for enhancing confidentiality or integrity verification and the computing environment may include a substitute for the trusted execution environments. In yet another example, the host device may be absent virtualization or include a different or an additional virtualized execution environment, such as container-based virtualization (e.g., operating system level virtualization).

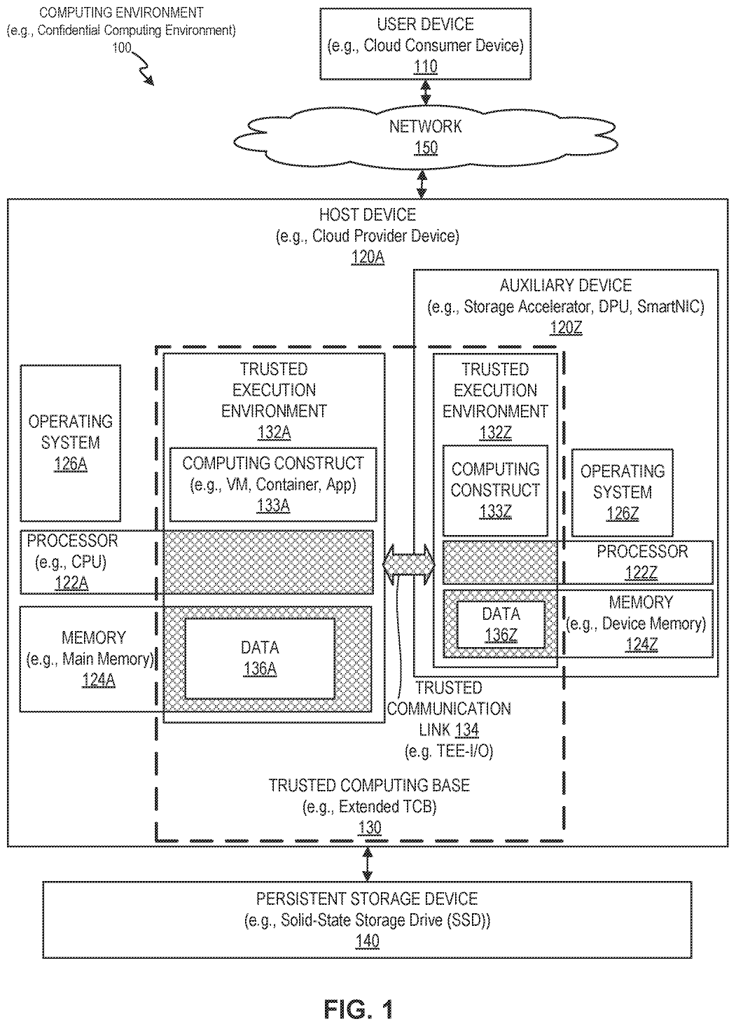

FIG. 1 depicts an illustrative architecture of elements of a computing environment 100, in accordance with an example of the present disclosure. It should be noted that other architectures for computing environment 100 are possible, and that the implementation of a computing environment utilizing embodiments of the disclosure are not necessarily limited to the specific architecture depicted. Computing environment 100 may be a computing environment that is configured to provide on-demand availability of computing resources to consumers without direct management by the consumers. In one example, computing environment 100 may be a cloud computing environment (e.g., public cloud, private cloud, hybrid cloud) because the user devices and host devices may be associated with different entities (e.g., cloud consumer v. cloud provider). In another example, computing environment 100 may be an on-premise computing environment in which the user devices and host devices are associated with the same entity (e.g., same company or enterprise). In the simplified example of FIG. 1, computing environment 100 may include a user device 110, a host device 120A, an auxiliary device 120Z, a trusted computing base 130, a persistent storage device 140, and a network 150.

User device 110 may be any computing device that consumes the computing resources of a host device 120A and may provide input data (e.g., code or configurations) that enable the host device 120A to execute computing tasks on behalf of user device 110. User device 110 may include one or more servers, workstations, desktop computers, laptop computers, tablet computers, mobile phones, robotic devices (e.g., drones, autonomous vehicles), personal digital assistants (PDAs), smart watches, other device, or a combination thereof.

Host device 120A may be a single host machine or multiple host machines arranged in a heterogeneous or homogenous group (e.g., cluster). In one example, host device 120A may be or include one more servers, workstations, personal computers (e.g., desktop computers, laptop computers), mobile computers (e.g., mobile phones, palm-sized computing devices, tablet computers, personal digital assistants (PDAs)), network devices (e.g., routers, switches, access points), data storage devices (e.g., USB drive, Network Attached Storage (NAS), Storage Area Network (SAN)), other devices, or a combination thereof.

Host device 120A may include one or more primary devices that include one or more processors 122A and memory 124A. Processor 122A may be or include a Central Processing Unit (CPU) and may be referred to as the primary processor, host processor, main processor, other term, or a combination thereof. Processor 122A may have an Instruction Set Architecture (ISA) that is the same or similar to x86, ARM, Power ISA, RISC-V, SPARC, MIPS, other architecture, or a combination thereof. Processor 122A may be coupled to memory 124A and memory 124A may be shared by one or more devices of host device 120A and may be referred to as main memory, host memory, primary memory, other term, or a combination thereof. Host device 120A may include or be associated with one or more auxiliary devices 120Z.

An auxiliary device 120Z may be a computing device that is communicably coupled with host device 120A and may perform one or more data processing tasks for host device 120A. Auxiliary device 120Z may be internal or external to host device 120A and may be a physical adapter, card, component, module, or other device that is physically located on the same chassis as host device 120A (e.g., same board, case, tower, rack, cabinet, room, building) or on a different chassis. Auxiliary device 120Z may perform data processing tasks that are the same or similar to the data processing tasks performed by processor 122A or may perform data processing tasks that are not performed by processor 122A. The data processing tasks performed by auxiliary device 120Z may involve or be related to data encryption (e.g., encrypting or decrying), data verification (e.g., integrity verification, error checks), data storage (e.g., storing or accessing), data compression (e.g., compress or decompress), data transfer (e.g., sending or receiving), data formatting (e.g, encoding or decoding), data analysis (e.g., forensic analysis), other data processing task, or a combination thereof. Auxiliary device 120Z may perform the data processing tasks using processor 122Z and memory 124Z.

Processor 122Z may supplement the data processing functions of the primary processor 122A and be referred to as an auxiliary processor, coprocessor, other term, or a combination thereof. In one example, processor 122Z may be similar to processor 122A and may operate as a Central Processing Unit (CPU) of auxiliary device 120Z. The instruction set architecture of processor 122Z may be the same or different from the instruction set architecture of processor 122A and may be the same or similar to ARM, RISC-V, Power ISA, x86, other standardized or proprietary ISA, or a combination thereof. In another example, processor 122Z may be or include one or more Application Specific Integrated Circuits (ASICs), Field Programmable Gate Arrays (FPGAs), microprocessors, controllers, or other processing devices. In either example, processor 122Z may include or manage one or more hardware accelerators and use memory 124Z to store data.

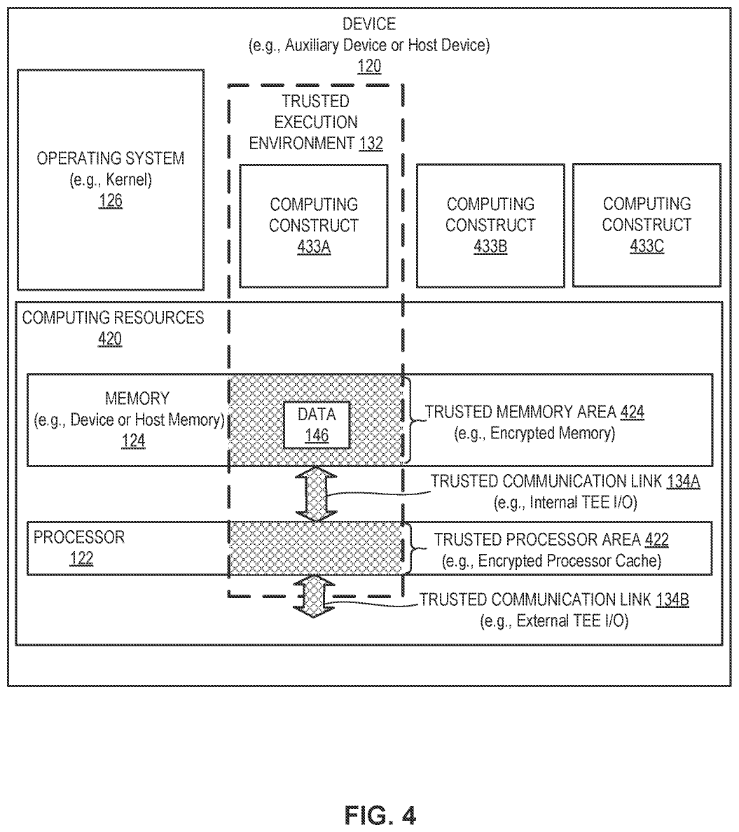

Memory 124Z may be coupled with processor 122Z of auxiliary device 120Z and may be referred to as auxiliary memory, device memory, other term, or a combination thereof. In one example, memory 124Z may be separate from memory 124A and may be exclusive to auxiliary device 120Z (e.g., discrete memory). In another example, memory 124Z may be a part of memory 124A (e.g., integrated with main memory). Memory 124A-Z and processors 122A-Z are discussed in more detail in regards to FIG. 4.

Auxiliary device 120Z may be the same or similar to a Data Processing Unit (DPU) in one embodiment. The data processing unit may contain one or more central processing devices (e.g., CPUs, ASICs, FPGAs), network controllers (e.g., NICs), programmable data acceleration engines (e.g., encryption engine, compression engine, or other engine), other computing resources, or a combination thereof. The data processing unit may have the generality and the programmability of a more traditional CPU while being specialized to operate more efficiently for data processing tasks that involve cryptographic operations (e.g., encryption, hashing), storage operations (e.g., write/read requests), networking operations (e.g., network requests), memory operations (e.g., store/access requests), or a combination thereof.

In one example, the data processing unit may be different from a traditional CPU because there may be a larger degree of parallelism and may differ from a traditional GPU because it may use Multiple Instruction, Multiple Data (MIMD) architecture rather than a Single Instruction/Multiple Data (SIMD) architecture. The MIMD architecture may be a hardware architecture that provides a set of processing cores that function asynchronously and independently. At any time, different processing cores may be executing different instructions on different pieces of data. The processing cores may access memory using a bus, mesh, hypercube, or hierarchical access technique.

In other embodiments, auxiliary device 120Z may be or include one or more Infrastructure Processing Units (IPU), Smart Network Interface Controller (NIC), storage controller (e.g., Hard Drive Device (HDD) controller or Solid-State Storage Drive (SSD) controller), Tensor Processing Unit (TPU), Graphical Processing Units (GPUs), other data processing device, or a combination thereof. The hardware and programming of auxiliary device 120Z and host device 120A and may support confidential computing and can be used to establish a trusted computing base 130.

Trusted Computing Base (TCB) 130 may be the portion of a computing environment 100 that is trusted by a particular computing resource. The particular computing resource may be a program or device that is internal to computing environment 100 or external to computing environment 100 and may be referred to as the trusting resource because it trusts the trusted resource. The trusting resource may establish a trust relationship with the trusted resource by verifying the trusted resource. The process of verifying the trusted resource is discussed in more detail in regards to FIG. 4 (e.g., attestation).

The trusted resource may be a set of computing resources of host device 120A, auxiliary device 120Z, persistent storage device 140, other device, or a combination thereof. The set of computing resources may include portions of hardware resources (e.g., hardware interfaces, processors, interconnects, memory, or other integrated circuits), portions of software resources (e.g., programming interfaces, executable code, firmware, drivers, services, kernels, operating systems, application, or other program), or a combination thereof. After the trusted computing base is established it can be modified to extend (e.g., expand) or retract (e.g., shrink) the set of trusted computing resources. In the example illustrated in FIG. 1, trusted computing base 130 may initially include the computing resources of trusted execution environment 132A (e.g., primary processor and main memory) and trusted computing base 130 may be expanded to include trusted communication link 134 and trusted execution environment 132Z (e.g., auxiliary processor and memory).

Trusted execution environments 132A-Z (TEEs) may each enable confidential computing by including a set of computing resources that are configured to protect data using techniques that enhance data confidentiality, data integrity, or a combination thereof. Trusted execution environments 132A-Z may protect the data using hardware based encryption that isolates the data of one or more computing processes (e.g., application, container, VM) from other processes running on the same computing device. In one example, the data of a process executing in the trusted execution environment may be encrypted using cryptographic keys that are accessible to a hardware processor of the computing device but are inaccessible to all the processes running on the computing device (e.g., hardware level encryption). The hardware processor may encrypt or decrypt the data of the process executing in the trusted execution environment when the process stores or accesses the data in memory. This enables the trusted execution environment to isolate data of a lower privileged process (e.g., virtual machine process) executing within the trusted execution environment from being accessed by a higher privileged processes (e.g., hypervisor or host OS) even though the higher privileged processes may be responsible for managing the lower privileged process. A trusted execution environment may provide code execution, storage confidentiality, and integrity protection, and may store, execute, and isolate data as discussed in more detail in regards to FIG. 4.

Trusted execution environment 132A and 132Z may each correspond to a different set of computing resources (e.g., sub-set of trusted computing base 130). In the example illustrated in FIG. 1, trusted execution environment 132A may have a set of computing resources that include the primary device of host device 120A and include a portion of processor 122A (e.g., host processor) and a portion of memory 124A (e.g., main memory) and may be described as the primary TEE, host TEE, main TEE, CPU-TEE, other term, or a combination thereof. Trusted execution environment 132Z may include computing resources of auxiliary device 120Z and include a portion of processor 122Z (e.g., auxiliary processor) and a portion of memory 124Z (e.g., auxiliary memory) and may be described as the auxiliary TEE, device TEE, DPU-TEE, other term, or a combination thereof.

Trusted communication link 134 may enable the data of a trusted execution environment to be transmitted between trusted execution environments in a security enhanced manner. For example, trusted communication link 134 may enable data 136A of trusted execution environment 132A to be accessed by trusted execution environment 132Z and stored as data 136Z within trusted execution environment 132Z. Trusted communication link 134 may include or traverse one or more interconnects, buses, networks, other communication link, or a combination thereof. Data transmitted over trusted communication link 134 may be encrypted or partially encrypted during transit. This may be advantageous because transmitting data 136A in an encrypted form may limit the ability of data 136A to be snooped while being transmitted between computing resources of different trusted execution environments (e.g., between processor 122A and processor 122Z).

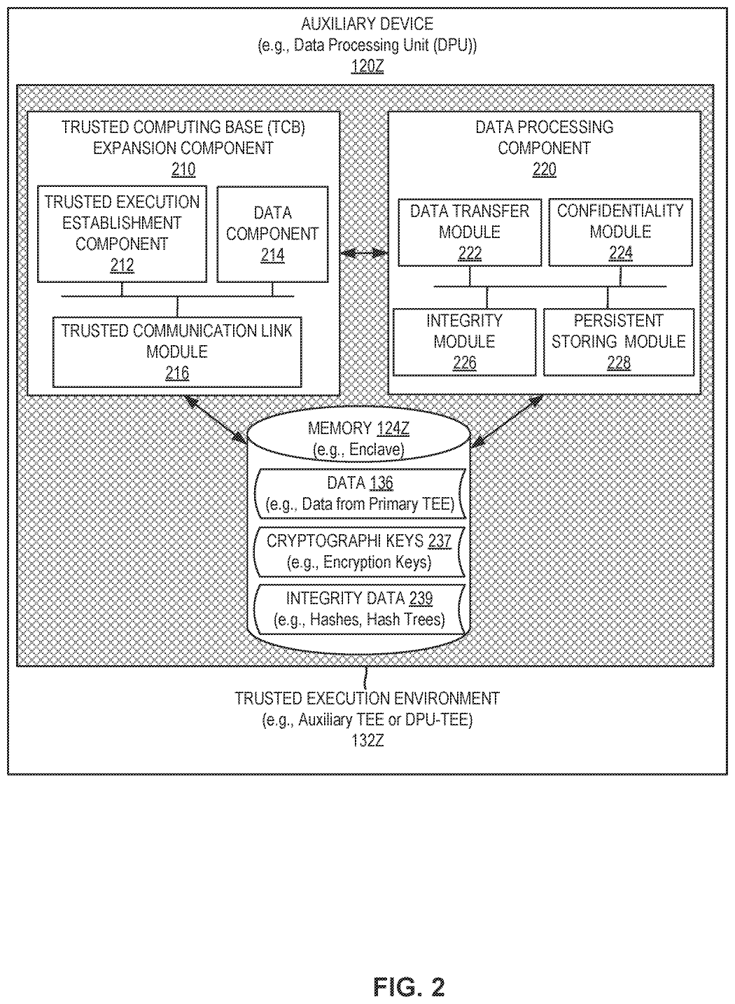

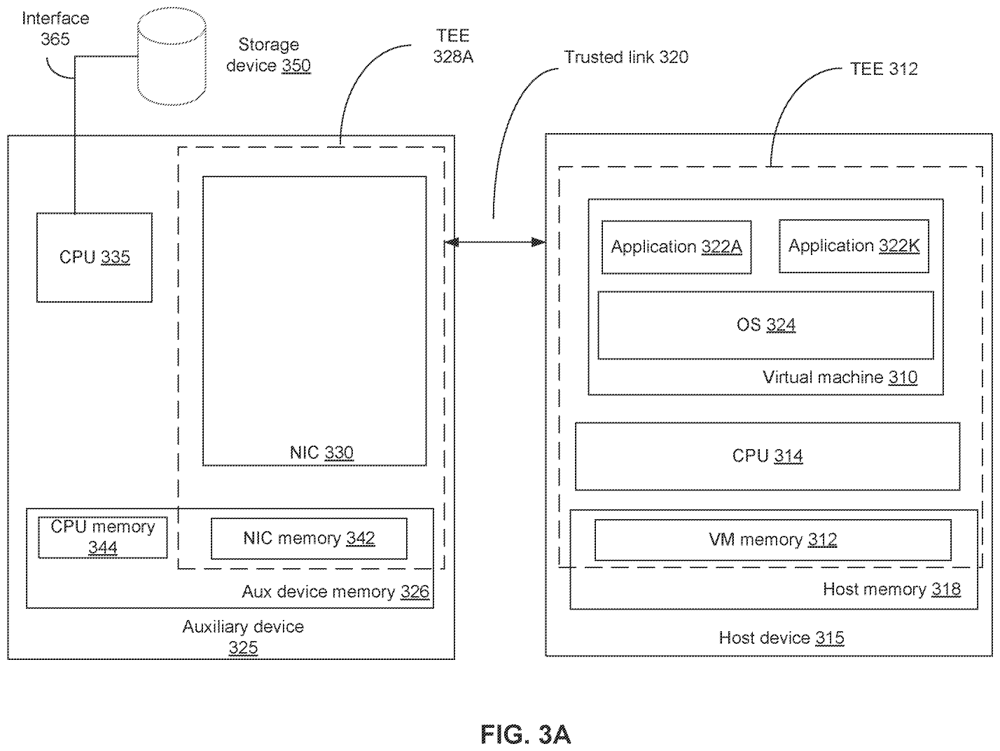

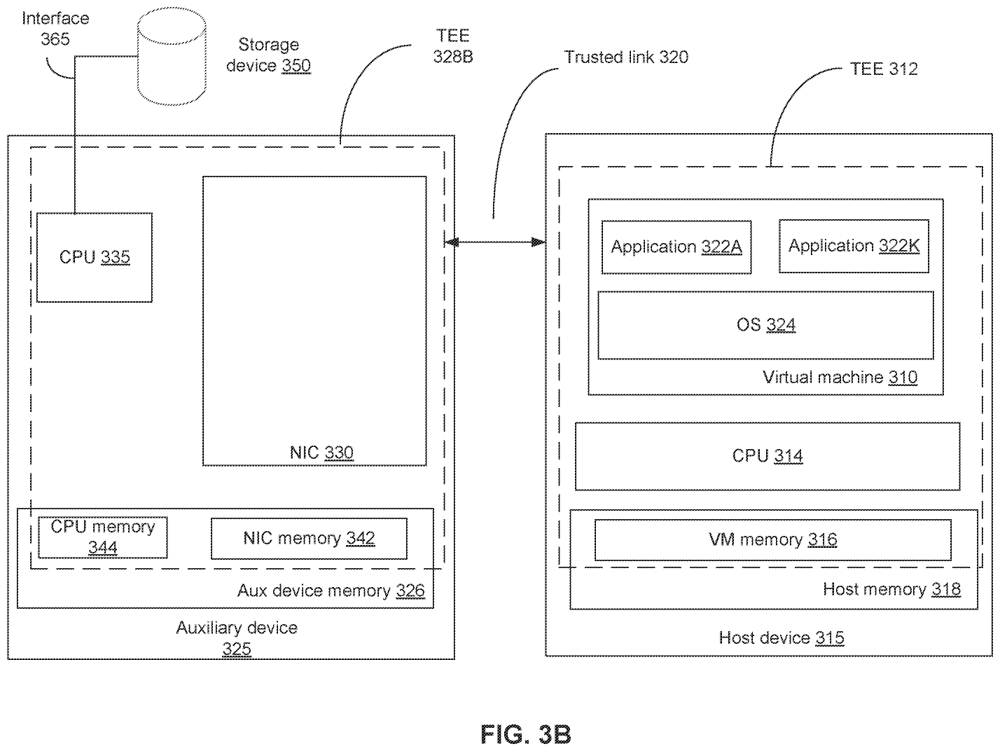

Transmitting data between trusted execution environments 132A and 132Z may involve one or more changes to the data encryption being used. In one example, the data may be encrypted using a first cryptographic technique (e.g., a first key) when stored in memory 124A, a second cryptographic technique when transmitted over trusted communication link 134 (e.g., a second key), and a third cryptographic technique when stored in memory 124Z (e.g., a third key). When switching between cryptographic techniques the data may be decrypted and then encrypted. In another example, the data that is stored in memory 124A may be encrypted using a cryptographic technique that is available to both trusted execution environments and can be accessed without changing the encryption. The establishment and use of trusted communication link 134 is discussed in more detail in regards to FIGS. 2 and 3 (e.g., TEE-IO).

Trusted execution environments 132A-Z may be ephemeral execution environments that store data using non-persistent data storage resources. The non-persistent data storage may include data storage devices that lose data in response to an interruption and may include volatile memory (e.g., main memory), processor cache (e.g., CPU Cache), processor registers (e.g., CPU registers), other non-persistent cache, or a combination thereof. The technology disclosed herein can enable a first trusted execution environment (e.g., Primary TEE 132A) to use a second trusted execution environment (e.g., auxiliary TEE 132Z) to store data (e.g., data 136A) on persistent storage device 140.

Persistent storage device 140 may include persistent data storage that does not lose data in response to a power cycle and may include one or more hard disk storage devices (e.g., Hard Disk Drives (HDD)), solid-state storage devices (e.g., Solid State Drives (SSDs)), tape drive storage devices, network storage devices, other persistent data storage medium, or a combination thereof. Persistent storage device 140 may be internal to host device 120A and accessible over a device bus or may be external to host device 120A and accessible over a network connection (e.g., communication link). Persistent storage device 140 may include one or more block-based storage devices, file-based storage devices, or a combination thereof. Block-based storage devices may provide access to consolidated block-based (e.g., block-level) data storage. File-based storage devices may provide access to consolidated file-based (e.g., file-level) data storage. In either example, the data of a trusted execution environment (e.g., Trusted VM) can be transmitted to and stored by persistent storage device 140.

Trusted execution environments 132A-Z can each have the same or different levels of granularity and protect a respective computing construct 133A-Z. The level of granularity of a TEE can depend on the computing construct that is being protected can be a Virtual Machine (VM), a container, a process, a thread, other stream of execution, or a combination thereof. A trusted execution environment for executing and protecting a VM may be referred to as Trusted Virtual Machine (TVM). A trusted execution environment for executing and protecting a container may be referred to as a Trusted Container (TC). A trusted execution environment for executing and protecting an application process may be referred to as a Trusted Application (TA) or Trusted Process (TP). In one example, trusted execution environment 132A may be established by host processor 122A and include a virtual machine or container and trusted execution environment 132Z may be established by auxiliary processor 122Z and be a TEE for one or more processes (e.g., processes managing encryption and persistent storage).

Computing environment 100 may include devices that support one or more levels of virtualization. The levels of visualization may include hardware level virtualization (e.g., VMs), operating system level virtualization (e.g., containers), other virtualization, or a combination thereof. Hardware level virtualization may involve the computing device (e.g., 120A, 120Z) running an operating system (e.g., 120A, 120Z) that supports a hypervisor (e.g., Virtual Machine Monitor (VMM)). The hypervisor may provide and manage hardware resources for use by one or more virtual machines. The hypervisor may be any program or combination of programs and may run on a host operating system or may run directly on the hardware (e.g., bare-metal hypervisor). The hypervisor may manage and monitor various aspects of the operation of the computing device, including the storage, memory, and network interfaces. The hypervisor may abstract the physical layer features such as processors, memory, and I/O devices, and present this abstraction as virtual devices to a virtual machine. In one example, the hypervisor may be the same or similar to Microsoft® Hypervisor (e.g., Hyper-V™), Open Source Software Hypervisor (e.g., Kernel-Based Virtual Machine (KVM)), VMware™ Hypervisor (e.g., ESX/ESXi, VMware Workstation, VMware Player, VirtualBox), IBM™ Hypervisor (e.g., PowerVM Hypervisor™) Citrix™ Hypervisor (e.g., Xen™, Citrix Hypervisor™, XenServer™), Oracle Hypervisor (e.g., VM Server for SPARC or x86), Parallels Desktop, Virtuozzo, other hypervisor, or a combination thereof.

The operating system virtualization may be provided by a computer program that provides computing resources to one or more containers. Operating system level virtualization may be implemented within a kernel of operating system 126A and may enable the existence of multiple isolated containers. In one example, operating system level virtualization may not require hardware support and may impose little to no overhead because programs within each of the containers may use the system calls of the same underlying operating system 126A. This may enable host device 120A to provide virtualization without the need to provide hardware emulation or be run in an intermediate virtual machine as may occur with hardware level virtualization.

The container may be the resource-constrained process space of the computing device (e.g., host device 120A) that can execute functionality of a program. A container may be referred to as a user-space instance, a virtualization engine (VE), a jail, or other term and may appear to a user as a standalone instance of the user space of operating system. Each container may share the same kernel but may be constrained to use only a defined set of computing resources (e.g., CPU, memory, I/O). In one example, operating system virtualization may be provided by an operating system virtualizer that wraps an application in a complete file system that contains the code, runtime, system tools, system libraries, and other programs that can be used by the application. The operating system virtualizer may be the same or similar to Docker®, ThinApp® by VMWare®, Solaris Zones® by Oracle®, or other program that automates the packaging, deployment, and execution of applications inside containers.

Network 150 may include one or more public networks (e.g., the internet), private networks (e.g., a local area network (LAN), wide area network (WAN)), or a combination thereof. In one example, network 150 may include a wired or a wireless infrastructure, which may be provided by one or more wireless communications systems, such as a wireless fidelity (WiFi) hotspot connected with the computer network 150 and/or a wireless carrier system that can be implemented using various data processing equipment, communication towers, etc.

FIG. 2 depicts a block diagram illustrating an example auxiliary device 120Z that may process and persistently store data of a primary TEE, in accordance with one or more aspects of the present disclosure. In the example illustrated, auxiliary device 120Z may include a trusted computing base expansion component 210 and a data processing component 220.

Trusted computing base expansion component 210 may enable auxiliary device 120Z to expand the trusted computing base of host device 120A to include computing resources of auxiliary device 120Z. The expansion may involve adding one or more trusted execution environments, trusted communication links, trusted interfaces, other computing resource, or a combination thereof. In the example illustrated, trusted computing base expansion component 210 may include trusted execution establishment component 212, data component 214, and a trusted communication link module 216.

Trusted execution establishment component 212 and data component 214 may enable auxiliary device 120Z to establish one or more trusted execution environments (e.g., auxiliary TEE 132Z) that include computing resources of auxiliary device 120. Components 212 and 214 may perform attestation, initiation, configuration, loading, and execution for the one or more auxiliary TEEs as discussed in detail below in regards to FIG. 4.

Trusted communication link module 216 may enable auxiliary device 120Z to establish a trusted communication link with a primary TEE executing on host device 120. In one example, the trusted communication link may be based on a Trusted Execution Environment Input/Output (TEE-I/O, TEE IO) architecture. The TEE IO architecture may be a form of trusted IO virtualization that can connect any TEE (e.g., primary TEE or auxiliary TEE) with a target computing resource of a device that is external to the TEE. The TEE may be associated with a TEE Security Manager (TSM) and the target computing resource may be associated with a Device Security Manager (DSM). The TSM and DSM may communicate to establish trusted communication link between the TEE and the target computing resources. The target computing resource may be a particular device interface such as an Assignable Device Interface (ADI), Virtual Function (VF), Physical Function (PF), other portion of the device, or a combination thereof. The communication between the TSM and DSM may comply with a Device Interface Management Protocol (DIMP) and involve sending one or more requests and responses that are used to manage the assignment or removal of the target computing resource (e.g., device interface) to the TEE. In one example, the trusted communication link may be established over a Peripheral Computer Interface Express (PCIe) connection and may use Integrity and Data Encryption (IDE) stream to transmit data using Transaction Layer Packets (TLPs) between multiple PCIe ports. In one example, the multiple PCIe ports may include at least one port associated with the TEE (e.g., port of processor 122A) and at least one port associated with the auxiliary device (e.g., port of processor 122Z)

Trusted communication link module 216 may use one or more trusted communication links to communicably couple the primary TEE and the auxiliary TEE. In one example, a single trusted communication link can be used to communicably couple the primary TEE and auxiliary TEE. The single trusted communication link may be between the primary TEE and one of the devices of auxiliary device 120Z (e.g., auxiliary processor or auxiliary memory), between the auxiliary TEE and one of the primary devices (e.g., host processor or host memory), or a combination thereof. In another example, a set of multiple trusted communication links may be used to communicably couple the primary TEE and auxiliary TEE. The set of trusted communication links may include a link between the primary TEE and an intermediate computing resource (e.g., device interface) and a link between the intermediate computing resource and the auxiliary TEE. In either example, the one or more trusted communication links can be initiated by the primary processor, auxiliary processor, primary TEE, auxiliary TEE, other computing resource, or a combination thereof.

Data processing component 220 may enable auxiliary device 120Z to process and persistently store data of the primary TEE in one or more persistent storage devices. In the example illustrated, data processing component 220 may include a data transfer module 222, a confidentiality module 224, an integrity module 226, and a persistent storing module 228.

Data transfer module 222 may enable auxiliary device 120Z to send or receive data of the primary TEE over one or more of the trusted communication links. The data may be transferred to or from the host memory (e.g., main memory), host processor (e.g., CPU), other computing resource of the host device, or a combination thereof. The data of the primary TEE may be stored in a portion of host memory associated with the primary TEE and may or may not be copied to one or more data structures (e.g., queue or buffer) before being received by data transfer module 222. The data structures may be stored at a location that is internal to the primary TEE (e.g., in the enclave), external to the primary TEE (e.g., bounce buffer in host memory or auxiliary memory), other storage location, or a combination thereof. Data transfer module 222 may receive the data of the primary TEE in response to transmitting a request (e.g., data pull), in the absence of a request (e.g., data push), or a combination thereof. Data transfer module 222 may detect that data is available to be processed using a polling technique (e.g., check for flag), alert technique (e.g., register a listener), other technique, or a combination thereof. Auxiliary device 120Z may store the received data in the auxiliary TEE before, during, or after the data is processed using confidentiality module 224 or integrity module 226.

Confidentiality module 224 may enable auxiliary device 120Z to encrypt and decrypt data of the primary TEE using a symmetric cryptographic system, asymmetric cryptographic system, other cryptographic system, or a combination thereof. A symmetric key cryptographic system may use the same cryptographic key to encrypt and decrypt data. Cryptographic keys used in a symmetric cryptographic system may be referred to as symmetric keys and may be identical keys (e.g., copies of the same key) or there may be a simple transformation to go between keys of a symmetric key pair. The symmetric key cryptographic system may involve stream ciphers, block ciphers, other cipher, or a combination thereof. The stream ciphers may encrypt individual elements (e.g., digits, characters) of a message one at a time. Block ciphers may take a set of elements and encrypt them as a single unit and may or may not pad the results so that it is a multiple of a block size of n bits (e.g., 64 bit, 128 bit, 256 bit, 1024 bit). In one example, the symmetric cryptographic system may be the same or similar to Galois/Counter Mode (GCM), Advanced Encryption Standard (AES), Triple Data Encryption Standard (3DES, TDES), International Data Encryption Algorithm (IDEA), Blowfish, Lattice-based cryptography, multivariate cryptography (e.g., rainbow scheme), super singular elliptic curve cryptography, super singular isogeny graphs cryptography, other cryptographic system, or a combination thereof.

The cryptographic system may also or alternatively be an asymmetric key cryptographic system that uses different keys for encryption or verification. A first key may be used to encrypt plaintext into ciphertext and a second key may be used to decrypt the ciphertext into plaintext. In one example, the asymmetric key cryptographic system may be a public key cryptographic system and the first key may be a public key (e.g., shared key) and the second key may be a private key (e.g., secret key). Other cryptographic systems may include any cryptographic scheme that provides privacy, integrity, authentication, authorization, non-repudiation, other features, or a combination thereof. Independent of the cryptographic system in use, confidentiality module 224 may store the cryptographic keys that are used in memory 124 as cryptographic keys 237.

Cryptographic keys 237 may include cryptographic keys for encrypting, verifying, transferring, or storing data of the primary TEE. Cryptographic keys 237 may be generated by computing resources of host device 120A, auxiliary device 120Z, other device, or a combination thereof. As used throughout this application, the term “cryptographic key” or “key” may be a general term that corresponds to any portion of cryptographic key data or other cryptographic keying material (e.g., bit sequence) that is used as input to a cryptographic function. The term key may correspond to an entire key, a fragment of a key (e.g., key part, key share), a combined key (e.g., aggregate key, composite key, combination key, merged key), other bit sequence, or a combination thereof. Cryptographic keys 237 may be represented in a human readable form (e.g., passcode, password), a non-human readable form (e.g., digital token), other form, or a combination thereof. Cryptographic keys 237 may be input for a cryptographic function, output of a cryptographic function, or a combination thereof. In one example, cryptographic keys 237 may include one or more encryption keys, decryption keys, session keys, transport keys, migration keys, authentication keys, authorization keys, integrity keys, verification keys, digital tokens, license keys, certificates, signatures, hashes, other data or data structure, or a combination thereof.

The data of the primary TEE may be compressed before, during, or after the data is encrypted. The compressing may be performed by computing resources of the host device 120A, auxiliary device 120Z, other device, or a combination thereof. In one example, the host device 120A (e.g., host processor) may compress the data of the primary TEE before it is transferred to the auxiliary device 120Z. In another example, the auxiliary device 120Z (e.g., processor 122Z and hardware accelerators) may compress the data of the primary TEE after it is received from host memory. In the latter example, auxiliary device 120Z may use the auxiliary TEE to compress the data of the primary TEE so that the data is not exposed to processes running on the auxiliary device 120Z (e.g., operating system 126Z). The compressing may result in the generation of compressed data and when the input is plaintext the result may be compressed plaintext and when the input is ciphertext the output may be compressed ciphertext.

Integrity module 226 may enable auxiliary device 120Z to generate and update integrity data 239. Integrity data 239 may represent the data of primary TEE that is persistently stored and may be used to verify that the data is not affected by an unauthorized change. The unauthorized change may occur because of a malfunction (e.g., write error/read error), a malicious change, an accidental change, other change, or a combination thereof. Integrity data 239 may include one or more hashes (e.g., digests) and one or more hash data structures (e.g., hash trees). Integrity module 226 may use hash functions to generate hashes and update integrity data 239. A hash may be generated from TEE data (e.g., hash), one or more existing hashes (e.g., hash of hashes), other data, or a combination thereof. In one example, integrity module 226 may enable auxiliary device 120Z to generate hashes based on the data that is being persistently stored and to update the hash data structure based on the generated hashes.

The hash data structure may represent data stored in the persistent storage device and may be a hash tree (e.g., Merkle tree). The hash tree may be a tree data structure with one or more leaf nodes and one or more non-leaf nodes. One or more of the leaf nodes (e.g., every leaf node) may be associated with the hash of a data block. One or more of the non-leaf nodes (e.g., every non-leaf node) may be associated with the hash of one or more of the hashes of its child nodes (e.g., a hash of hashes). Therefore, the hash tree may be referred to as a tree of hashes and the leaf nodes may include hashes of data blocks and non-leaf nodes may include hashes of the hashes of respective child nodes. When a non-leaf node has multiple child nodes, the subsequent hash (e.g., hash of a hash) may involve concatenating one or more hash values. The concatenation may occur before applying the subsequent hash or after applying the subsequent hash. For example, the hash values of two leaf nodes may each be hashed and the results concatenated or may be concatenated and the result hashed. In either case, the resulting hash of a hash may be associated with one or more parent nodes of the leaf nodes. The same hash function or different hash functions may be used for the hashing of the data block and the hashing of the hash values. In other examples, hash data structure may have a different structure that is the same or similar to a hash list, a hash chain, other data structure, or a combination thereof.

Auxiliary device may use hashes of the hash data structure to perform data verification (e.g, integrity check, security check). The data verification may occur when reading data from the persistent storage device, writing data to the persistent storage device, other persistent storage operation, or a combination thereof. The data verification may involve computing a hash from data that is read from the persistent storage device and comparing the computed hash to a hash of the hash data structure. The number of hashes that are computed may depend on the amount of the hash data structure that is available to auxiliary device 120Z (e.g., stored in memory 124Z). When the entire hash data structure is stored in memory 124Z, auxiliary device 120Z may compare the computed hash to a hash of the leaf node and avoid computing any hash of hashes. When the hash data structure is partially available (e.g., root node hash but absent leaf node hashes), auxiliary device 120Z may compute the hash of the read data and one or more hashes of hashes. The quantity of hashes of hashes that are computed will depend on how much of the hash data structure is unavailable. For example, if the root node hash is available and the remaining portion of the hash data structure is unavailable then the entire hash data structure would have to be recomputed so that the computed hash of the root node (e.g., computed root hash) can be compared to the available root node hash (e.g., existing root hash) to perform the data verification.

Auxiliary device 120Z may store any portion of the hash data structure. The size of the portion may be selected by the Auxiliary device 120Z and may depend on the amount of available memory resources, processing resources, other computing resources, or a combination thereof. In one example, auxiliary device 120Z may store the root hash of the hash data structure (e.g., hash at the root node) to reduce the amount of storage resources consumed (e.g., minimize memory use). In another example, auxiliary device 120Z may store the entire hash data structure to reduce the amount of processing resources consumed to compute the hash data structure (e.g., minimize processor use). In other examples, another sized portion of hash data structure may be selected by auxiliary device 120Z to be stored in memory 124Z, memory 124A, persistent storage device 140, other storage location, or a combination thereof.

In one example, auxiliary device 120Z may function as a trust anchor and may optimize the integrity verification of data stored in persistent storage by skipping some or all of the data verification performed when reading data from persistent storage device 140 (e.g., skip integrity check for read operation). This may enable auxiliary device 120Z to compute and use hashes when storing the data but avoid computing or using hashes when reading the data. Auxiliary device 120Z may determine whether to function as a trust anchor before, during, or after initiation time (e.g., startup), runtime (e.g., time of read or write), other time, or a combination thereof. Determining whether to function as a trust anchor may involve auxiliary device 120Z determining that it can and has authenticated the persistent storage device 140 (e.g., attestation) and is capable of detecting a change to persistent storage device 140. Detecting the change may involve detecting persistent storage device 140 has been removed, replaced, tampered with, configured, modified, other change, or a combination thereof. When auxiliary device 120Z is capable of detecting these changes it can avoid the data verification in the absence of the changes.

Persistent storing module 228 may enable auxiliary device 120Z to communicate with one or more persistent storage devices to store and retrieve data of the primary TEE. Auxiliary device 120Z may store and retrieve the data by generating and transmitting storage commands. The storage commands may include write commands, read commands, move commands, copy commands, other commands, or a combination thereof. A storage command may be the same or similar to an instruction, operation, or opcode and may be associated with one or more storage identifiers. The storage identifier may indicate the persistent storage device or storage location in the persistent storage device and may be a physical location or logical location. The storage identifiers may be or include a namespace identifier (e.g., Namespace ID), a zone identifier (e.g., zone ID), a block identifier (e.g., Logical Block Addresses (LBAs)), Physical Block Addresses (PBAs)), a file identifier (e.g., file ID, file name, or file path), a record identifier (e.g., record ID, index), a content identifier (e.g., hash of content), other storage identifier, or a combination thereof. In one example, the persistent storage device may be a Non-Volatile Memory Express (NVMe) storage device and the storage commands generated by persistent storing module 228 may comply with the NVMe standard.

The persistent storage device may be directly or indirectly connected to auxiliary device 120Z. The persistent storage device may be directly connected when auxiliary device 120Z and the persistent storage device are connected to the same interconnect, bus, or network. The persistent storage device may be indirectly connected when one or more auxiliary devices are between auxiliary device 120Z and the persistent storage device. For example, auxiliary device 120Z may be directly connected with the host processor and there may be one or more intermediate auxiliary devices between auxiliary device 120Z and the persistent storage device. In this latter example, the data processing and command generation discussed herein may be distributed across the multiple auxiliary devices and each persistent storage device may correspond to at least one of the multiple auxiliary devices (e.g., DPU directly attached to each SSD).

FIGS. 3A-3B schematically illustrate example implementations of a trusted computing base spanning over a host device and an auxiliary device. As schematically illustrated by FIG. 3A, a trusted virtual machine (VM) 310 may run in a TEE 312 implemented by the processor (e.g. CPU) 314 of the host device 315. The VM 310 may run applications 322A-322K managed by the operating system (OS) 324. The VM 310 may communicate, via a trusted communication link 320, with the TEE 328A implemented by the auxiliary device 325, thus forming a trusted computing base (TCB).

The auxiliary device 325 may be represented by a data processing unit (DPU) implementing a peripheral device controller. Accordingly, the auxiliary device 325 may include a peripheral device controller (e.g., a NIC) 330 and a storage interface processor (e.g., a CPU) 335. In some implementations, the internal processor of the peripheral device controller may include TEE capabilities, and thus can establish a TEE (e.g., TEE 328A).

The CPU 335 may, in various implementations, be inside or outside of the TCB perimeter. In some implementations, the internal processor of the peripheral device controller may include TEE capabilities, and thus can establish a TEE (e.g., TEE 328A or a separate TEE (not shown in FIGS. 3A-3B)). In some implementations, the TEE 328A may include multiple internal TEEs with respective security policies enforced on their internal interfaces.

The auxiliary device memory 326 may include a NIC memory buffer 342 and a CPU memory buffer 344. The NIC 330 may communicate to the host device 315, e.g., via a PCIe interface, over which the trusted communication link 320 may be established (e.g., by encrypting the data to be transmitted).

The CPU 335 may run an operating system managing various applications, such as drivers that facilitate communications of the auxiliary device 325 with a storage device 350. The CPU 335 and/or auxiliary circuitry and components (not shown in FIG. 1 for clarity and conciseness) may implement a Non-Volatile Memory Express (NVMe)-compliant interface for communicating with the storage device 350. Notably, while in the example implementations of FIGS. 3A-3B the storage device 350 is a local storage device which may be accessed, e.g., via a PCIe physical interface, in various other implementations, the storage device 350 may be represented by a remote storage device which may be accessible via a network. Thus, example implementations of FIGS. 3A-3B may be employed for facilitating secure RDMA solutions. An RDMA-enabled NIC may implement a secure RDMA protocol to transfer the data directly between a local memory buffer and a networked storage device, without any involvement of a host processor. Accordingly, when an application issues an RDMA read or write request, the application data is transferred directly to/from the networked storage device, thus reducing latency and enabling fast data transfers.

In the illustrative example of FIG. 3A, the CPU 335 is untrusted (and thus is excluded from the TCB perimeter) as it only handles encrypted data, as explained in more detail below. In operation, the VM 310 may transmit the data residing in the VM memory buffer 316 allocated in the host memory 318, via the trusted communication link 320, to the NIC 330 (e.g., for storing the data on the storage device 350). The NIC 330 may encrypt and optionally compress the data. The encrypted data, which may initially be stored in the NIC buffer 342 of the auxiliary device memory 326, may be copied to the CPU buffer 344 of the auxiliary device memory.

The CPU 335 may implement data read/write operations from/to the storage device 350 via a NVMe interface 365. As noted above, the CPU 335 may, in various implementations, reside inside or outside of the TCB perimeter. In the example implementation of FIG. 3A, the CPU 335 resides outside of the TCB perimeter, since it only handles encrypted data received from the NIC 330 via the CPU memory buffer 344 or retrieved from the storage device 350. Thus, the drivers and/or other programs running on the CPU 335 for facilitating the data read/write operations need not to be modified in order to accommodate the described TCB implementation.

In an illustrative example, a storage write operation may involve retrieving, by the CPU 335, the encrypted data from the CPU memory buffer 344 and forwarding the data via the NVMe interface 365 to the storage device 350; a storage read operation may involve reading, by the CPU 335, the encrypted data from the storage device 350 via the NVMe interface 365, storing the data to the CPU memory buffer and notifying the NIC 330 of the data being ready for retrieval.

Conversely, in the example implementation of FIG. 3B, the CPU 335 is included into the TCB perimeter, which spans the TEE 312 implemented by the host device 315, as well as the TEE 328B implemented by the auxiliary device 325, including the NIC 330 and the CPU 335. Accordingly, the NIC 330 and the CPU 335 may securely exchange data via the CPU memory buffer 344 allocated in the auxiliary device memory 326. Notably, in the example implementation of FIG. 3B, the CPU memory buffer 344 resides within the TCB perimeter and thus facilitates secure communications between the two trusted components, i.e., the NIC 330 and the CPU 335.

In an illustrative example, the NIC 330 may store, to the CPU memory buffer 344, unencrypted data to be retrieved by the CPU 335, which may encrypt and optionally compress the data before storing it on the storage device 350. Conversely, upon retrieving encrypted data from the external storage device, the CPU 335 may decrypt and optionally un-compress the data before storing it to the CPU memory buffer in the auxiliary device memory 326 for consumption by the NIC 330.

FIG. 4 depicts an example of a trusted execution environment 132 within a device 120, in accordance with an embodiment of the present disclosure. In one example, device 120 may be the same as host device 120A or 415 and the trusted execution environment 132 may be the same as primary trusted execution environment 132A or TEE 412. In another example, device 120 may be the same as auxiliary device 120Z or 325 and trusted execution environment 132 may be the same as auxiliary trusted execution environment 132Z or TEE 426A-426B. In either example, device 120 may include computing resources 420, a trusted execution environment 132, an operating system 126, and one or more computing constructs 144A-C. It should be noted that other architectures for device 120 are possible, and that the implementations of the computing device utilizing embodiments of the disclosure are not necessarily limited to the specific architecture depicted.

Computing resources 420 may include one or more hardware devices that perform computing tasks for device 120. Computing resources 420 may include one or more data storage devices, processing devices, Input/Output devices, program code (e.g., firmware), other aspects, or a combination thereof. One or more devices of the computing resources 420 may be combined or consolidated into one or more physical devices or may partially or completely emulated as a virtual device or virtual machine. In the example in FIG. 2, computing resources 420 may include memory 124 and processor 122.

Memory 124 may include any data storage device that is capable of storing data and may include physical memory devices. Memory 124 may be the same or similar to memory 124A or memory 124Z of FIG. 1. The physical memory devices may include volatile memory devices (e.g., non-persistent memory, Dynamic Random Access Memory (DRAM), Static Random Access Memory (SRAM)), non-volatile memory devices (e.g., Non-Volatile Random Access Memory (NVRAM), Persistent Memory (PMEM)), other types of memory devices, or a combination thereof.

Memory 124 may be capable of storing data 146 associated with one or more of the computing constructs 433A-C. In one example, data of computing construct 433A may be received from a device that is internal or external to device 120. The data may be encrypted using a cryptographic key that was provided (e.g., determined, derived, generated, or assigned) by device 120 or by a different computing device. The received data may be decrypted using the same cryptographic key or a derivative of the cryptographic key and the decrypted data may be loaded into the trusted execution environment 132 (as shown by data 146) before, during or after being re-encrypted.

Processor 122 may be communicably coupled to memory 124 and be capable of executing instructions encoding arithmetic, logical, or I/O operations. Processor 122 may be the same as processor 122A or the same as processor 122Z of FIG. 1. Processor 122 may be or include one or more general processors, Central Processing Units (CPUs), Graphical Processing Units (GPUs), Digital Signal Processor (DSP), Application Specific Integrated Circuits (ASICs), secure cryptoprocessors, Secure Elements (SE), Hardware Security Module (HSM), Trusted Platform Module (TPM), other processing unit, or a combination thereof. Processor 122 may be a single core processor, which may be capable of executing one instruction at a time (e.g., single pipeline of instructions) or a multi-core processor, which may simultaneously execute multiple instructions. Processor 122 may interact with memory 124 and provide one or more features defined by or offered by trusted systems, trusted computing, trusted platform module (TPM), hardware security module (HSM), secure element (SE), other features, or a combination thereof.

Processor 122 may establish one or more trusted execution environments 132 across multiple hardware devices of computing resources 420 (e.g., processor and memory devices). Processor 122 may include instructions (e.g., opcodes) to initiate, configure, and maintain the trusted execution environments. In one example, processor 122 may establish trusted execution environment 132 using technology from Intel® (e.g., Software Guard eXtensions® (SGX), Trusted Domain Extensions® (TDX)), technology from AMD® (e.g., Secure Encrypted Virtualization® (SEV), Secure Memory Encryption (SME, SME-ES), technology from ARM® (e.g., TrustZone®, Confidential Compute Architecture (CCA)), IBM PEF, RISC-V Sanctum, other technology, or a combination thereof.

Trusted execution environment 132 may be a security enhanced area in device 120 that may guard the data of a computing construct 433A from being accessed by other computing constructs on device 120. Trusted execution environment 132 may enhance security by enhancing confidentiality (e.g., reducing unauthorized access), integrity (e.g., reduce unauthorized modifications), availability (e.g., enable authorized access), non-repudiation (e.g., action association), other aspect of digital security or data security, or a combination thereof. Trusted execution environment 132 may be the same or similar to a trust domain, trust zone, other term, or a combination hereof. Trusted execution environment 132 may protect data 146 while data 146 is in use (e.g., processed by processor 122), is in motion (e.g., transmitted over network 150), is at rest (e.g., stored in persistent storage device 140), or a combinational thereof. Trusted execution environment 132 may be a set of one or more trusted execution environments and each of the trusted execution environments may be referred to as an instance of a trusted execution environment (i.e., TEEi). Each trusted execution environment 132 may isolate data of at least one process executed in trusted execution environment 132 from processes executing external to the trusted execution environment by storing the data 146 in a trusted memory area 424.

Trusted memory area 424 may be an area of memory 124 that is associated with trusted execution environment 132. As shown in FIG. 2, trusted memory area 424 may be a part of trusted execution environment 132 and may store data 146 of computing construct 433A in an encrypted form. Data 146 may be encrypted and decrypted by hardware devices (e.g., processor 122) using cryptographic input that includes one or more cryptographic keys. In one example, the cryptographic keys may be accessible to the hardware devices (e.g., processor 122) and may be inaccessible to operating system level processes executed by the hardware device. In another example, the cryptographic keys may be accessible to hardware devices and one or more computing constructs, such as, the computing construct associated with the trusted execution environment (e.g., computing construct 144A). In either example, the encryption and decryption performed by the hardware device may be referred to as hardware based encryption, hardware level encryption, hardware assisted encryption, hardware enforced encryption, process transparent encryption, virtual machine transparent encryption, container transparent encryption, other term, or a combination thereof.

Trusted memory area 424 may include a portion of memory and may be referred to as an encrypted memory area. The encrypted memory area may be a contiguous or non-contiguous portion of virtual memory, logical memory, physical memory, other memory abstraction, or a combination thereof. The encrypted memory area may correspond to or be mapped to a portion of primary storage (e.g., main memory), auxiliary devices (e.g., device memory or device processor), persistent storage device (e.g., solid state storage), other persistent or non-persistent storage, or a combination thereof. In one example, the encrypted memory area may be a portion of main memory associated with a particular process and the processor may encrypt the data when storing the data in the memory area and may decrypt the data when retrieving the data from the memory area. The data in the memory area may be transformed (e.g., encrypted or decrypted) before, during, or after it is stored in or retrieved from the memory area and may remain in an encrypted form while in the encrypted memory area.

Trusted memory area 424 may store the data as one or more storage units. The storage units may be logical or physical units of data storage for managing the data (e.g., storing, organizing, or accessing the data). A storage unit may include a contiguous or non-contiguous sequence of bytes or bits. In one example, a storage unit may be a virtual representation of underlying physical storage units, which may be referred to as physical storage blocks. Storage units may have a unit size that is the same or different from a physical block size provided by an underlying hardware resource. The storage unit may include volatile or non-volatile data storage. In one example, storage units may be a memory segment and each memory segment may correspond to an individual memory page, multiple memory pages, or a portion of a memory page. In other examples, each of the storage units may correspond to a portion (e.g., block, sector) of a mass storage device (e.g., hard disk storage, solid state storage). The data in trusted memory area 424 may be transmitted into and out of trusted processor area 422 using storage units that are the same or different (e.g., cache line/block same size as memory page).

Trusted processor area 422 may be a portion of processor 122 that is associated with computing construct 433A and guards data of one or more computing processes from being accessed or modified by computing processes. Trusted processor area 422 may include a portion of processor 122 that stores the data (e.g., processor cache and registers) and a portion of processor 122 that executes the data (e.g., processor cores). Trusted processor area 422 may store the data in an encrypted form or in a decrypted form when it is present on the processor and in either example, the data of the computing construct may be protected from being accessed or modified by other processes via the design of the processor and encryption may not be required to ensure isolation of the data when the data is within the processor or within a processor core. The data in trusted processor area 422 may be transmitted to other hardware devices using trusted communication links 134A-B.

Trusted communication links 134A-B may enable the data of trusted execution environment 132 to be transmitted between hardware devices in a security enhanced manner. Trusted communication links 134A-B may be the same or similar to trusted communication link 134 of FIG. 1. The data may be transmitted over one or more system interconnects, buses, networks, or other communication links in an encrypted or partially encrypted form. As shown in FIG. 2, trusted communication link 134A may enable the data to be transmitted internal to trusted execution environment 132 and between trusted processor area 422 and trusted memory area 424. Trusted communication link 134B may enable the data to be transmitted external to trusted execution environment 132 to one or more other devices.

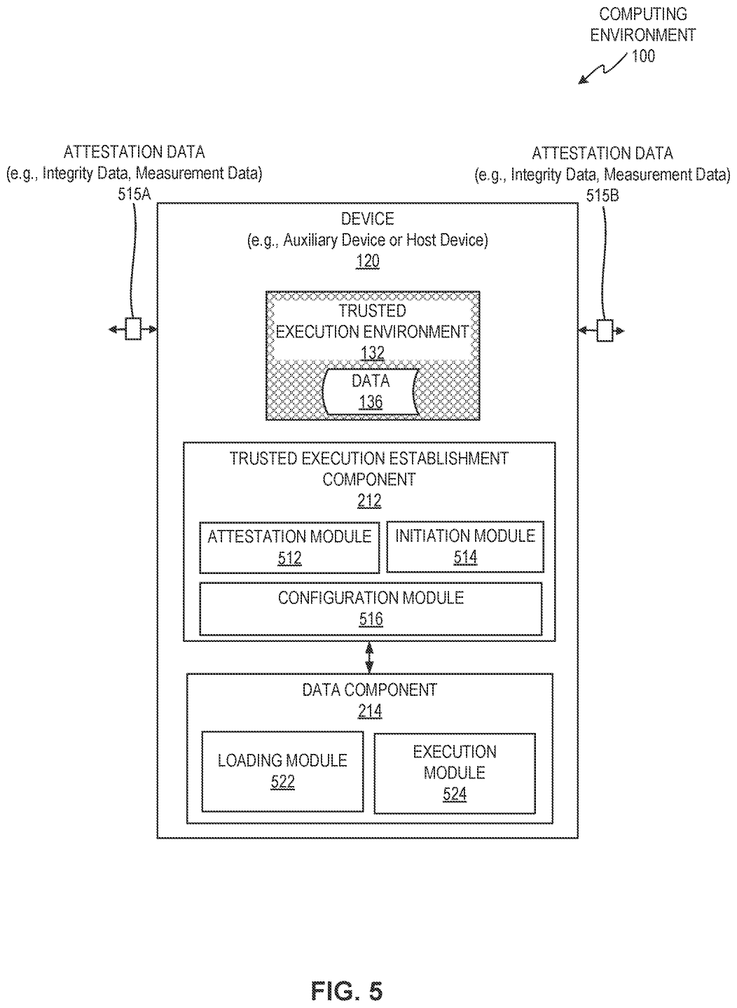

FIG. 5 depicts a block diagram illustrating portions of computing environment 100 and how attestation is used to establish a trusted execution environment 132 within device 120. In one example, device 120 may be host device 120A and the attestation may be used to establish primary trusted execution environment 132A. In another example, device 120 may be auxiliary device 120Z and the attestation may be used to establish auxiliary trusted execution environment 132Z. In either example, device 120 may include a trusted execution establishment component 212 and a data component 214. The components and modules discussed herein may be performed by any portion of device 120. For example, one or more of the components or modules discussed below may be performed by processor circuitry, processor firmware, a driver, a kernel, an operating system, an application, other computing resource, or a combination thereof. More or less components or modules may be included without loss of generality. For example, two or more of the components may be combined into a single component, or features of a component may be divided into two or more components. In one implementation, one or more of the components may reside on different devices.

Trusted execution establishment component 212 may enable device 120 to establish one or more trusted execution environments 132 in device 120. Establishing a trusted execution environment may involve creating a new trusted execution environment or updating an existing trusted execution environment. Each of the one or more trusted execution environments may be associated with a set of one or more computing processes and may store and execute data of the set of computing processes. In one example, trusted execution establishment component 212 may include an attestation module 512, an initiation module 514, and a configuration module 516.

Attestation module 512 may enable device 120 to perform an attestation to verify the integrity of device 120 (e.g., integrity of computing resources 520, operating system 126, and/or processor 122). Attestation may enable a trusting resource (e.g., program) to check the capabilities of a trusted resource (e.g., processor 122 of device 120) and to detect unauthorized changes to programs, hardware devices, other portions of computing device, or a combination thereof. The unauthorized changes may be the result of malicious, defective, or accidental actions by a program or hardware device.

The attestation may involve performing local attestation, remote attestation, or a combination thereof. Local attestation may involve enabling a program executed locally on device 120 to verify the integrity of device 120. Remote attestation may involve enabling a program executed remotely on a different computing device (e.g., user device 110) to verify the integrity of device 120. The remote attestation may be performed non-anonymously by disclosing data that uniquely identifies device 120 or anonymously without uniquely identifying device 120 (e.g., Direct Anonymous Attestation (DAA)). In either example, attestation module 512 may perform one or more attestation operations to determine attestation data 136A-B and may transmit attestation data 136A-B to the programs executing on the local or remote devices for verification.

Attestation data 515A-B may be based on the configuration of device 120 and may represent the capabilities of the computing resources, trusted execution environment, executable code, or a combination thereof. Attestation data obtained or generated by the computing resources (e.g., processor, memory, firmware, BIOS) may be the same or similar to integrity data (e.g., hash or signature of executable code), identification data (e.g., processor model or instance), cryptographic data (e.g., signature keys, endorsement keys, session keys, encryption or decryption keys, authentication keys), measurement data, report data, configuration data, settings data, other data, or a combination thereof. In one example, determining the attestation data may involve attestation chaining in which attestation data of different portions of device 120 may be combined before, during, or after being obtained. This may involve determining attestation data for one or more layers of the device 120 and the layers may correspond to hardware device layer (e.g., hardware platform attestation data), program layer (e.g, code attestation data), other layer, or a combination thereof.

The program that receives the attestation data may use the attestation data to verify the capabilities of device 120. The program may execute a verification function to verify the device 120 in view of the attestation data. The verification function may take as input the attestation data and provide output that indicates whether the device 120 is verified (e.g., trusted). In one example, the attestation data may include integrity data (e.g., a message authentication code (MAC)) and the verification function may analyze a portion of attestation data to generate validation data. The verification function may then compare the received integrity data with the generated validation data to perform the attestation (e.g., compare received MAC with generate MAC).

Attestation module 512 may perform operations before, during, or after trusted execution environment 132 is established on device 120 and may provide attestation data that is specific to the initiation, configuration, or execution of the trusted execution environment 132. In one example, attestation may involve performing a key exchange, establish hardware root of trust, and/or provide measurement and configuration values of trusted execution environment 132.

Initiation module 514 may enable device 120 to initiate the configuration of a trusted execution environment before, during, or after the execution of attestation module 512. Initiation module 514 may execute one or more instructions recognized by the processor (e.g., opcodes for ARM CCA/TrustZone, Intel TDX/SGX, or AMD SEV). The instructions may be called by a program associated with an application, kernel, operating system, hypervisor, bootloader, Basic Input Output Services (BIOS), hardware adapter, other entity, or a combination thereof. In one example, a program that will execute in the trusted execution environment may initiate the creation of the trusted execution environment. In another example, a program may initiate the creation of the trusted execution environment and the trusted execution environment may be used for executing another program. In either example, after the trusted execution environment is initiated it may be configured by configuration module 516.

Configuration module 516 may enable device 120 to configure a trusted execution environment to store or execute data of a computing process (e.g., application or virtual machine). Configuration module 516 may configure the trusted execution environment in view of configuration data provided by a process initiating or using the trusted execution environment, by a processor, storage device, other portion of device 120, or a combination thereof. The configuration data may be provided as input before, during, or after the trusted execution environment is initiated, created, or updated. As discussed above, a trusted execution environment may include a trusted memory area, a trusted processor area, trusted communication link, or a combination thereof and the configuration data may include data for configuring one or more of these. For example, configuration data may include computing construct data (e.g., processes identifier (PID), virtual machine identifier (VMID)), storage data (e.g., storage size or location), cryptographic data (e.g., encryption key, decryption key, seed, salt, nonce), other data, or a combination thereof. One or more of these may be configured or customize and associated with the trusted execution environment for the computing process. In one example, the trusted execution environment may include an encrypted memory area and the configuration data may indicate a size of the encrypted memory area that will be allocated for the trusted execution environment (e.g., size of memory for a trusted memory area).

Configuration module 516 may configure different aspects of the trusted execution environment to use different cryptographic systems. The different cryptographic systems may use different cryptographic functions, cryptographic settings, cryptographic keys, cryptographic inputs, other cryptographic data, or a combination thereof. In one example, data of a computing process that will be executed by the trusted execution environment 132 may be encrypted using a first cryptographic system (e.g., encrypted using a location independent transport key) when loaded by the processor and may be encrypted using a second cryptographic system (e.g., encrypted using a location dependent storage key) when stored in the encrypted storage. This may be advantageous because the data may be more vulnerable to attack when it is stored on a removable storage device (e.g., memory module or persistent storage device) then when it is transferred over the system bus and therefore different cryptographic techniques may be used.

Data component 214 may enable device 120 to load data 136 of a computing process (e.g., VM) into trusted execution environment 132 to enhance the confidentiality and integrity of the processing of data. Data 136 may include data of one or more programs and include executable code (e.g., machine instructions), non-executable data (e.g., configuration data, parameter values, settings), other data, or a combination thereof. In one example, data component 214 may include a loading module 522 and an execution module 524.

Loading module 522 may include instructions for loading data into trusted execution environment 132. Loading data 136 may involve copying data, moving data, updating data, modifying data, or other action affecting data 136. The process of loading data 136 may involve copying data into the trusted processor area from the trusted memory area, copying data into the trusted memory area from an untrusted area, other copy operation, or a combination thereof. Trusted execution environment 132 may store the data of the computing process in the trusted memory area and the loading may involve the processor receiving the data in an encrypted form over a bus from the trusted memory area. Trusted execution environment 132 may include or be associated with a particular portion of memory (e.g., specific range of addresses) and a particular portion of the processor (e.g, particular core) and the data that is loaded into trusted execution environment 132 may be accessible to the computing process and inaccessible to the kernel prior to the enabling.

Execution module 524 may enable device 120 to cause data 136 (e.g., executable code) to execute in the trusted execution environment 132. As discussed in regards to FIG. 5, device 120 may include an operating system 126 that manages the execution of multiple computing processes. Execution module 524 may be a part of operating system 126 or interact with operating system 126 to initiate the execution of executable code as a computing process. Although the operating system may not have access to a decrypted version of the data in trusted execution environment 132, it may be able to manage when the computing process executes and the operations it performs.

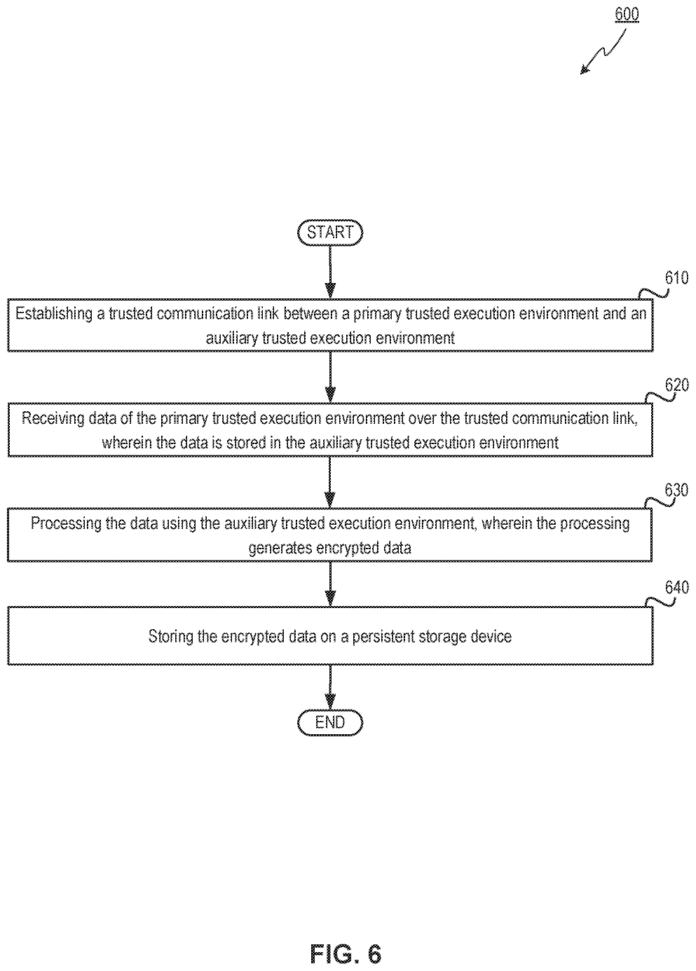

FIG. 6 is a flow chart of a method 600 for processing and persistently storing data of a trusted execution environment, in accordance with some embodiments of the present disclosure. Method 600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible. Method 600 may be performed by processing logic of an auxiliary device 120Z, host device 120A, other device, or a combination thereof and may begin at operation 610.

At operation 610, the processing logic can establish a trusted communication link between a primary trusted execution environment and an auxiliary trusted execution environment. The primary trusted execution environment may include memory of a host device and the auxiliary trusted execution environment may include memory of the auxiliary device. The host device may have a host operating system that manages the memory of the host device and the primary trusted execution environment and the auxiliary trusted execution environment may include data that is encrypted and inaccessible to the host operating system. In one example, the primary trusted execution environment may be established by a Central Processing Unit (CPU) of the host device and the auxiliary trusted execution environment may be established by a Data Processing Unit (DPU) of the host device.

In an illustrative example, the auxiliary device may be represented by a data processing unit (DPU) implementing a peripheral device controller, such as a network interface controller (NIC). The peripheral device controller may include one or more processors, including general purpose and/or specialized processors, and one or more hardware accelerators. The peripheral device controller may further include a host interface controller (e.g., a PCIe switch) implementing an interface between the host device and the peripheral device controller. The auxiliary device may further include another processor (e.g., a general purpose or a specialized processor) implementing an interface between a storage device and the auxiliary device (e.g., a NVMe-compliant interface for communicating with a storage device). This processor may, in various implementations, be inside or outside of the TCB perimeter.

At operation 620, the processing logic can receive data of the primary trusted execution environment over the trusted communication link and the data may be stored in the auxiliary trusted execution environment. In one example, the primary trusted execution environment may be a Trusted Virtual Machine (TVM) and the data may be virtual machine data. The auxiliary trusted execution environment may include hardware accelerators to write the virtual machine data to the persistent storage device and to read the virtual machine data from the persistent storage device.

At operation 630, the processing logic can process the data using the auxiliary trusted execution environment and generate encrypted data. Processing the data by the auxiliary trusted execution environment may involve compressing the data of the primary trusted execution environment to generate compressed data and encrypting the compressed data to generate encrypted data.

In an illustrative example, the storage interface processor of the auxiliary device may be excluded from the auxiliary trusted execution environment. Accordingly, processing the data by the auxiliary trusted execution environment may involve encrypting the data by the processor of the peripheral device controller and storing the encrypted data in a memory buffer of the peripheral device memory. The encrypted data may then be retrieved from the memory buffer by untrusted storage interface processor and may be forwarded to the storage device.

In another illustrative example, the storage interface processor of the auxiliary device may be included into the auxiliary trusted execution environment. Accordingly, processing the data by the auxiliary trusted execution environment may involve storing unencrypted data by the processor of the peripheral device controller in a memory buffer of the peripheral device memory. The data may then be retrieved from the memory buffer by untrusted storage interface processor and may be encrypted and optionally compressed before being forwarded to the storage device.

The processing may also or alternatively involve generating a digest (e.g., a hash) of the data and updating a hash tree based on the digest. The hash tree may represent the data stored in the persistent storage device.

At operation 640, the processing logic can store the encrypted data on a persistent storage device. The persistent storage device may be a solid state storage device and the storing may involve generating a write command that complies with a Non-Volatile Memory Express (NVMe) protocol. The processing logic may transmit, using the auxiliary trusted execution environment, the write command and the encrypted data to the persistent storage device or an auxiliary device for the persistent storage device (e.g., DPU for SSD, SAN, or NAS). The processing logic may also or alternatively use the auxiliary trusted execution environment to read data from the persistent storage device. The processing logic may process the read data by decrypting and verifying the read data. The processing logic may then provide the processed data to the primary trusted execution environment using the trusted communication link. Responsive to completing the operations described herein above with references to operation 640, the method may terminate.

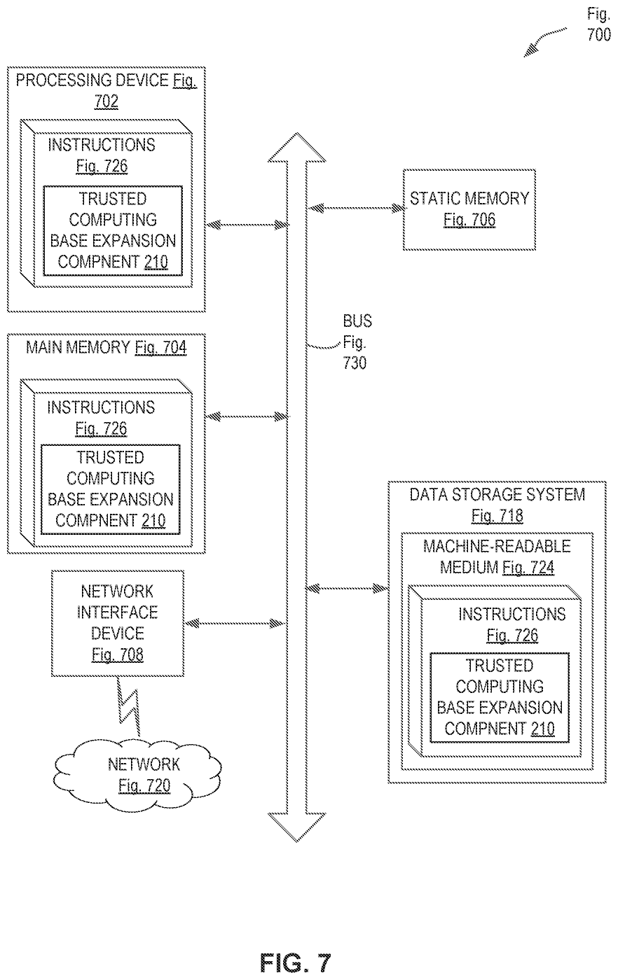

FIG. 7 illustrates an example machine of a computer system 700 within which a set of instructions, for causing the machine to perform any one or more of the methodologies discussed herein, can be executed. In some embodiments, the computer system 700 can be a computing device that includes a processor with a cache controller, a memory controller, or combination thereof. In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702 (e.g., Processor 122), a main memory 704 (e.g., read-only memory (ROM), flash memory, dynamic random access memory (DRAM) such as synchronous DRAM (SDRAM), etc.), a static memory 706 (e.g., flash memory, static random access memory (SRAM), etc.), and a data storage system 718, which communicate with each other via a bus 730.

Processing device 702 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 702 can also be one or more special-purpose processing devices such as an application specific integrated circuit (ASIC), a field programmable gate array (FPGA), a digital signal processor (DSP), network processor, or the like. The processing device 702 is configured to execute instructions 726 for performing the operations and steps discussed herein. The computer system 700 can further include a network interface device 708 to communicate over the network 720.

The data storage system 718 can include a machine-readable storage medium 724 (also known as a non-transitory computer-readable medium) on which is stored one or more sets of instructions 726 or software embodying any one or more of the methodologies or functions described herein. The instructions 726 can also reside, completely or at least partially, within the main memory 704 and/or within the processing device 702 during execution thereof by the computer system 700, the main memory 704 and the processing device 702 also constituting machine-readable storage media. The machine-readable storage medium 724, data storage system 718, and/or main memory 704 can correspond to memory 124A of FIG. 1.

In one embodiment, the instructions 726 include instructions to implement functionality corresponding to the trusted computing base expansion component 220 of FIG. 2. While the machine-readable storage medium 724 is shown in an example embodiment to be a single medium, the term “non-transitory machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., non-transitory computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a device memory;
a first processor, communicably coupled to the device memory, the first processor to perform operations comprising:
establishing a trusted communication link between a primary trusted execution environment and an auxiliary trusted execution environment, wherein the primary trusted execution environment comprises memory of a host device and the auxiliary trusted execution environment comprises the device memory;
receiving data of the primary trusted execution environment over the trusted communication link, wherein the data is stored in the auxiliary trusted execution environment;
processing the data using the auxiliary trusted execution environment, wherein the processing generates encrypted data; and
storing the encrypted data on a storage device.

2. The system of claim 1, wherein the primary trusted execution environment is established by a Central Processing Unit (CPU) of the host device and wherein the auxiliary trusted execution environment is established by a Data Processing Unit (DPU) of the host device, wherein the DPU comprises the first processor and the device memory.

3. The system of claim 2, wherein the DPU comprises a network interface controller (NIC) comprising the first processor coupled, via a host interface, to the host device; and
wherein the DPU further comprises a second processor coupled, via a data storage interface, to the storage device.

4. The system of claim 3, wherein the second processor is outside of the auxiliary trusted execution environment, and wherein processing the data using the auxiliary trusted execution environment further comprises:
encrypting the data by the first processor;
storing, by the first processor, the encrypted data in a memory buffer of the device memory;
retrieving the encrypted data from the memory buffer by the second processor;
forwarding the encrypted data, by the second processor over the data storage interface, to the storage device.

5. The system of claim 3, wherein the second processor is within the auxiliary trusted execution environment, and wherein processing the data using the auxiliary trusted execution environment further comprises:
storing, by the first processor, the data in a memory buffer of the device memory;
retrieving the data from the memory buffer by the second processor;
encrypting the data by the second processor;
forwarding the encrypted data, by the second processor over the data storage interface, to the storage device.

6. The system of claim 3, wherein the second processor implements a secure Remote Device Memory Access (RDMA) protocol.

7. The system of claim 1, wherein the primary trusted execution environment comprises a Trusted Virtual Machine (TVM).

8. The system of claim 1, wherein processing the data using the auxiliary trusted execution environment further comprises:
compressing, using the auxiliary trusted execution environment, the data of the primary trusted execution environment to generate compressed data.

9. The system of claim 1, wherein processing the data using the auxiliary trusted execution environment comprises:
generating, using the auxiliary trusted execution environment, a digest of the data.

10. The system of claim 1, wherein the storage device comprises a solid state storage device and wherein the storing comprises:
generating, using the auxiliary trusted execution environment, a write command that complies with a Non-Volatile Memory Express (NVMe) protocol; and
transmitting, using the auxiliary trusted execution environment, the write command and the encrypted data to a DPU of the persistent storage device.

11. The system of claim 1, wherein the operations further comprise:
processing, using the auxiliary trusted execution environment, data read from the persistent storage device, wherein the processing comprises decrypting and verifying the read data; and
providing the processed data to the primary trusted execution environment using the trusted communication link.

12. A method comprising:
establishing a trusted communication link between a primary trusted execution environment and an auxiliary trusted execution environment, wherein the primary trusted execution environment comprises memory of a host device and the auxiliary trusted execution environment comprises device memory;
receiving data of the primary trusted execution environment over the trusted communication link, wherein the data is stored in the auxiliary trusted execution environment;
processing the data using the auxiliary trusted execution environment, wherein the processing generates encrypted data; and
storing the encrypted data on a persistent storage device.

13. The method of claim 12, wherein the primary trusted execution environment is established by a Central Processing Unit (CPU) of the host device and wherein the auxiliary trusted execution environment is established by a Data Processing Unit (DPU) of the host device.

14. The method of claim 13, wherein the DPU comprises a network interface controller (NIC) comprising a first processor coupled, via a host interface, to the host device; and
wherein the DPU further comprises a second processor coupled, via a data storage interface, to the storage device.

15. The method of claim 14, wherein the second processor is outside of the auxiliary trusted execution environment, and wherein processing the data using the auxiliary trusted execution environment further comprises:
encrypting the data by the first processor;
storing, by the first processor, the encrypted data in a memory buffer of the device memory;
retrieving the encrypted data from the memory buffer by the second processor;
forwarding the encrypted data, by the second processor over the data storage interface, to the storage device.

16. The method of claim 14, wherein the second processor is within the auxiliary trusted execution environment, and wherein processing the data using the auxiliary trusted execution environment further comprises:
storing, by the first processor, the data in a memory buffer of the device memory;
retrieving the data from the memory buffer by the second processor;
encrypting the data by the second processor;
forwarding the encrypted data, by the second processor over the data storage interface, to the storage device.

17. A non-transitory machine-readable storage medium storing instructions which, when executed, cause a processing device to perform operations comprising:
establishing a trusted communication link between a primary trusted execution environment and an auxiliary trusted execution environment, wherein the primary trusted execution environment comprises memory of a host device and the auxiliary trusted execution environment comprises device memory;
receiving data of the primary trusted execution environment over the trusted communication link, wherein the data is stored in the auxiliary trusted execution environment;
processing the data using the auxiliary trusted execution environment, wherein the processing generates encrypted data; and
storing the encrypted data on a persistent storage device.

18. The non-transitory machine-readable storage medium of claim 17, wherein the primary trusted execution environment is established by a Central Processing Unit (CPU) of the host device and wherein the auxiliary trusted execution environment is established by a Data Processing Unit (DPU) of the host device, wherein the DPU comprises the device memory and a network interface controller (NIC) comprising a first processor coupled, via a host interface, to the host device; and
wherein the DPU further comprises a second processor coupled, via a data storage interface, to the storage device.

19. The non-transitory machine-readable storage medium of claim 18, wherein the second processor is outside of the auxiliary trusted execution environment, and wherein processing the data using the auxiliary trusted execution environment further comprises:
encrypting the data by the first processor;
storing, by the first processor, the encrypted data in a memory buffer of the device memory;
retrieving the encrypted data from the memory buffer by the second processor;
forwarding the encrypted data, by the second processor over the data storage interface, to the storage device.

20. The non-transitory machine-readable storage medium of claim 18, wherein the second processor is within the auxiliary trusted execution environment, and wherein processing the data using the auxiliary trusted execution environment further comprises:
storing, by the first processor, the data in a memory buffer of the device memory;
retrieving the data from the memory buffer by the second processor;
encrypting the data by the second processor;
forwarding the encrypted data, by the second processor over the data storage interface, to the storage device.
